(19) United States
(12) Patent Application Publication
(10) Pub. No.: US 2010/0321521 A1
(43) Pub. Date: Dec. 23, 2010

(54) Method of automatic white-balance calibration

(76) Inventor: Chung-Hao Chang, Yuanlin Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/457,837

(22) Filed: Jun. 23, 2009

(51) Int. Cl. H04N 9/73; G06K 9/00

(52) U.S. Cl. 348/223.1; 382/167; 348/E09.051

(57) ABSTRACT

Provided is a method of automatic white-balance calibration. The method firstly uses a predefined gain. Each color value for pixels of an inputted image is calculated. A number of the placements representing the pixels within each gray region of a color space are then obtained. Next, a new gain is obtained by linearly combining those placements. Further, in order to overcome a possible chromatic aberration on account of the overlapping regions in the color space, the method introduces a specific deletion ratio to delete a portion of placements positioned in the overlapping regions. Therefore the method provides a proper image. Furthermore, users may decide a level of the chromatic aberration by adjusting the predefined gain.

### BACKGROUND OF THE INVENTION

1. Field of the Invention

The present invention relates to a method of automatic white-balance calibration, more particularly to employ the placements in each gray region of color space, and to obtain a new gain by a linear combination, so as to output a more accurate image.

2. Description of Related Art

Human eyes can be calibrated automatically to adapt every light source, and the white object is still shown as white under different light sources. The digital recorder, such as a digital camera or a digital camcorder, intuitionally record the proportion of the light reflected from the object. For example, the object recorded in the recorder is white with additional green under a green-aberration fluorescent light, or the object has additional yellow under a yellow-aberration streetlamp.

Although the human eyes may not see every white object as white correctly under every light sources, the conventional recorder even more results in serious chromatic aberration. The automatic white-balance (AWB) technology is preferably used to solve the chromatic aberration.

The conventional automatic white-balance process is developed on a basis of Gray World assumption. Generally, the objective of the automatic white-balance process is to obtain a gain, which is used to average red, green and blue values.

For example, reference is made to FIG. 1 shows a gray or white region of an rg color space diagram, where r=R/(R+G+B) and g=G/(R+G+B), under every kind of light sources. Particularly the relevant color temperature ranges between 3000K and 6500K. In the conventional scheme for obtaining the gain, a specific light source, such as the shown D65, D50, CW, A, or FL, is firstly introduced. A gray region in the rg color space diagram is then selected. After that, R, G and B values are separately accumulated in the gray region. The gain is obtained according to the values G/R and G/B. It is noted that the rg color space diagram can be an RGB space, an YCbCr space, a HIS space and a HSV space.

Referring now to the conventional automatic white-balance process, the process is to ascertain a light source for an image by analyzing the white pixels of a predefined region in a color space. The values G/R and G/B of each image's pixel can be drawn in the color space, the placements tend to a specific region of a light source since most placements are positioned in the light source. The tendency can be used to determine the white pixel and the light source. Next, the gain used for white-balance process can be adjusted by comparing the average of each R, G, B value of the white pixel.

FIG. 2 shows a schematic diagram of the system of automatic white-balance of the conventional way using the average of each R, G and B value. A color processing unit 207 is shown in the figure. The unit 207 is used to receive the original gains 201, 203, and 205 of each pixel. After a comparison process operated between the averages and the gains, the gains may be adjusted. After that, the adjusted gains are used to perform the automatic white-balance. A storage/display unit 209 is then used to store or display the R, G, B values which have been adjusted.

The shown system can be applied to the image under every kind of light sources. Since each light source appears different R, G, B values, the gains therefor are also different. In the conventional way, the automatic white-balance process is to select the regions having most points in the white or gray regions, and then a gain is obtained by accumulating the R, G, B values in the selected region.

For example, the image with green grass, skin color, sunset, or blue sky may cause aberration since it easily judges the erroneous light source. Thus the conventional way may still produce the erroneous judgment since the regions of different light sources have the overlapping regions.

### SUMMARY OF THE INVENTION

In light of the conventional art, the present invention provides a novel method of automatic white-balance calibration. In which, the invention originally adopts the predefined gains for all light sources. By referring to the numbers of placements positioned in all or parts of the regions in the color space, a new gain is obtained by linearly combining the placements and the predefined gains. The new gain can be used to correct the erroneous determination of the gray region due to the overlapping regions therebetween. Thereby, it obtains a more accurate image.

According to one of the embodiments of the present invention, a set of predefined gains for the gray regions are firstly introduced. The numbers of an image's pixels positioned in the gray regions of the color space is calculated. A weighting for each region is then determined based on each region's number of the pixels. By incorporating the weightings and the predefined gains, in order to perform the automatic white-balance process, the new gain with reference to a ratio between the R, G, B values is obtained.

Since there are the overlapping regions between the regions in the color space, the placements positioned in the overlapping regions may cause an erroneous determination of the light source and chromatic aberration. Therefore, the present invention provides an approach to solve the aberration by setting a suitable weighting with reference to the placements in the overlapping region.

The features of the invention at least include:

(1) a predefined gain is introduced, and a new gain is obtained by performing a linearly combination;

(2) the predefined gain helps a user control a color tone to be shown; and

(3) an incorrect color under an erroneous determination can be prevented.

According to one of the embodiments, the claimed method of automatic white-balance calibration includes a first step of inputting an image, and a next step of extracting a red value, a green value and a blue value of each pixel through an image analysis. Next, the method is to calculate the placements of the values in a specific color space. Particularly, an aberration problem caused by the placements within the overlapping regions around the gray regions is further under a consideration. Any one of the placements within the overlapping regions possibly causes an erroneous determination of the light source, and then an aberration occurs. Further, a deletion ratio is introduced to eliminate a portion of placements having the aberrations possibly causing the erroneous determination.

After that, the placements within the overlapping regions are obtained, and a portion of these placements are deleted. Then a new gain is obtained and be beneficial to perform the automatic white-balance.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 shows a schematic rg color space diagram of the prior art;

FIG. 2 shows a schematic diagram of the conventional system of automatic white-balance using the average of each R, G, B value;

FIG. 3 shows a schematic reference of the color space diagram of the present invention;

FIG. 4 is a flow chart of the method of automatic white-balance calibration of the embodiment of the present invention;

FIG. 5 shows a schematic diagram of the overlapping regions in the color space;

FIG. 6 is a flow chart of the method of automatic white-balance calibration in consideration of the erroneous light source judgment because of the overlapping regions.

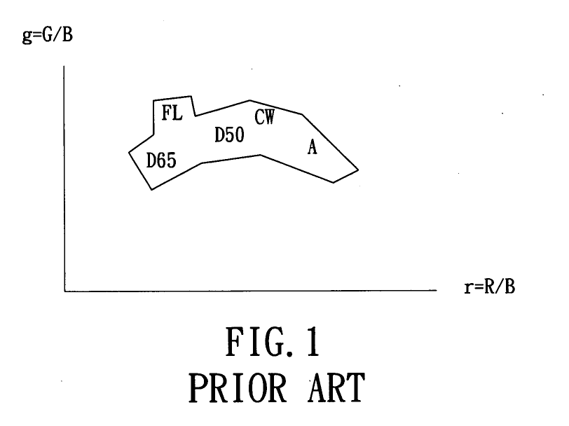

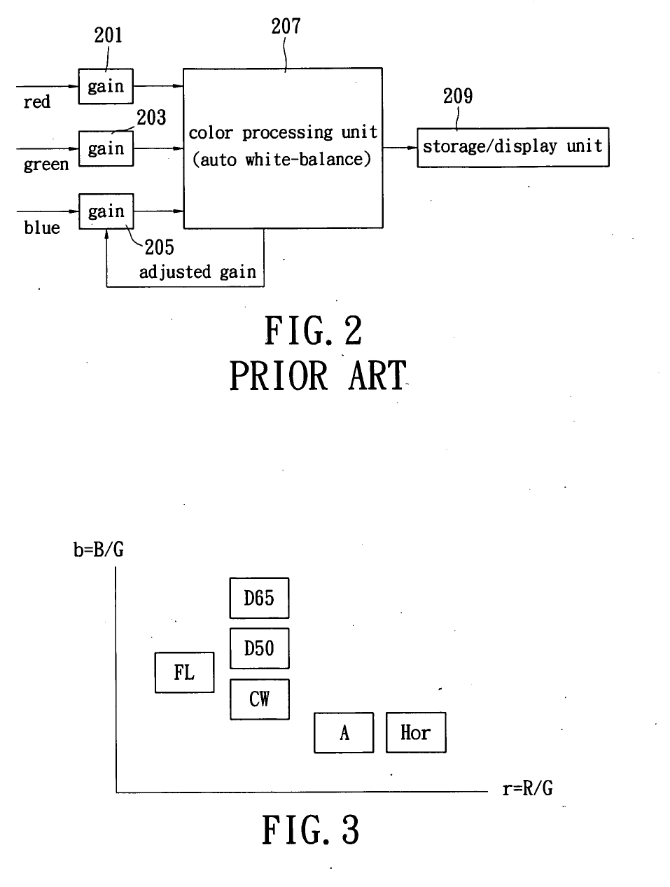

### DETAILED DESCRIPTION OF THE PREFERRED EMBODIMENTS

A general GrayWorld assumption is also used for the automatic white-balance calibration of the present invention. A plurality of gains are predefined for all the light sources in advance. Preferably, a new gain is obtained by linearly combing the predefined gains and a plurality of predefined white or gray regions. There are the overlapping regions around the regions of different light sources in the general color space. The overlapping regions may cause the erroneous determination of the light source. The erroneous determination may further result in the chromatic aberration as adjusting the color based on the predefined gain. Therefore, the present invention provides a method to correct the erroneous determination of light source by means of incorporating a weighting into adjusting a new gain for the overlapping region.

Reference is made to FIG. 3 showing a diagrammatic color space used for the embodiment of the present invention. The color space illustrates a proportional relationship of the red, green and blue value of each pixel of an inputted image. The vertical-axis shows b=B/IC, that represents a ratio of a blue value to a green value of the pixels. The horizontal-axis shows r=R/G namely a ratio of a red value to a green value of the pixels. Each diagrammatic rectangle represents the gray or white region of a specific light source, including D65, D50, FL, CW, A and Hor. Based on the shown gray region, a gain for a specific light source can be calculated.

The predefined gray regions of the light sources including D65, D50, FL, CW, A and Hor are established, and used to acquire their predefined gains. According to this diagram, there are at least six predefined gains are obtained. These gains can be formulated as the equations (1), (2) and (3):

PreDefGain_{—}R[i](the red gain, i=1-6) (1)

PreDefGain_{—}G[i](the green gain, i=1-6) (2)

PreDefGain_{—}B[i](the blue gain, i=1-6) (3)

If the more the light sources have, the color temperatures cover more, and the obtained gains get more.

After obtaining the predefined gains, the inputted image is under an analysis. In which a red value (R), a green value (G), and a blue value (B) of each pixel of the image are obtained. Then these values are transformed to an rb color space as shown in FIG. 3. After that, which predefined region the each point (the placement) positions undergoes an analysis. For example, if there are points positioned within a gray region of the light source D65, the number of the points is summed as a first accumulative value count[1]. If there are points positioned within the gray region of the light source D50, the number therein is summed as a second accumulative value count[2], and so forth. More accumulative values are generated therefore. The described accumulative values can be the number of the placements within all the gray regions. Alternatively, the accumulative value can be the number of the placements within parts of the gray regions of the color space. For instance, the gray regions having more counts are used to be accumulated.

The mentioned accumulative values are multiplied by the predefined gains therefor individually, so as to obtain a new gain for the current inputted image. The relevant equation (4) is shown as:

Gain_new=(Σcount[i]*PreDefGain[i])/(Σcount[i]) (4)

Therein i indexes the gray regions of the color space as shown in FIG. 3, the count[i] is the accumulative value, and PreDefGain[i] formulated by the equations (1), (2) and (3) is the predefined gain for each gray region. For example, if there are six gray regions, i ranges over 1 through 6. Besides using all the gray regions, the parts of regions having more counts can be selected to perform linear combination for calculating the new gain.

A value, such as the first accumulative value count[1], for one of the gray regions is multiplied by the region's predefined gain PreDefGain[1]. More, the value, such as the second accumulative value count[2] for the second gray region is multiplied by the corresponding predefined gain PreDefGain[2]. The two values and so forth after the multiplication operations are added afterward. An accumulative value is obtained after accumulating the values for every gray region. The accumulative value divided by the number of all placements positioned within all gray regions equals the new gain.

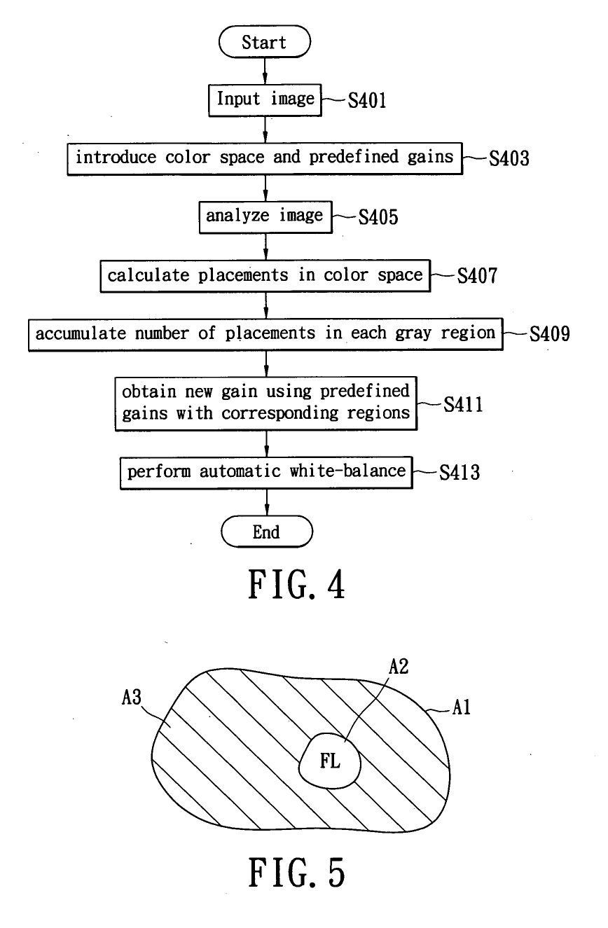

The mentioned scheme is illustrated as the flow chart of the method of automatic white-balance calibration shown in FIG. 4.

In the beginning of the steps, the automatic white-balance calibration system of the invention receives an inputted image (step S401). The system can be implemented as an apparatus or a circuit. Next, a color space is introduced (step S403). The image is then under an analysis, and each pixel's red value, green value and blue value are extracted from the image. A ratio between the values is calculated in step S405, such as the ratio B/G, and R/G.

After that, the values of each pixel of the image are sketched in the color space. The placements positioned in one or more gray regions are then obtained. The method goes to calculate the number of the placements in each gray region of the color space (step S407). The numbers of every gray region are summed up in an accumulative value that is count[i] described in equation (4) (step S409). The equation (4) is then used to calculate a new gain in step S411. This new gain is particularly used for performing the automatic white-balance process (step S413).

More particularly, if the predefined gain originally renders the regions of the color space a standard gray, the new gain calculated by equation (4) is equivalent to the conventional gain which is obtained by employing each value's ratio. In one embodiment, the new gain is obtained from G_sum/R_sum and G_sum/B_sum, wherein G_sum is the sum of green values, R_sum is the sum of red values, and B_sum is the sum of blue values.

According to one of the embodiments of the present invention, a user can flexibly decide his preferred chromatic aberration since the invention employs a predefined gain to deduce the new gain. Therefore, the user can create a specific chromatic aberration by defining the predefined gain. The effect of aberration can be a blue-aberration, a red-aberration or the like. The user-defined gain is used to obtain a new gain through the equation (4). Through this new gain, a white-balance process is performed to the image. The image then involves an effect with chromatic aberration, including cool-tone color and warm-tone color.

Moreover, by referring to the relationship between the gray or white regions in the color space, there exists a portion of overlapping areas. Under the above-described image analysis, the overlapping portion may induce the problem of erroneous determination of light source. Further, the overlapping portions may often be the reasons for the erroneous determination. In order to solve the erroneous determination made by the overlapping regions, the present invention particularly provides an automatic white-balance method which incorporates an aspect of weighting into the regions of light sources.

Reference is made to FIG. 5 showing the schematic diagram of the overlapping regions in the color space. The overlapping gray regions may induce the chromatic aberration, as described above. The figure shows an overlapping region laying between a green region (A1) and a gray region of the FL region (A2). In this case, the placements positioned in the overlapping region can not be clearly identified as the region belonged to the light source FL or a green object by an analysis. If all the pixels are laying the FL region (A2) after a transformation, it is determined that FL is undoubtedly the light source. If there are some pixels laying the overlapping region, namely the region (A3), the claimed method is to delete a certain number of the placements positioned in both the regions A2 and A3 in accordance with a ratio. The deletion ratio is described in equation (5), thereby to deal with the possible chromatic aberration.

FL_count−Green_count*p% (5)

wherein FL_count is the number laying the FL region A2, and Green_count is the number after deleting the placements positioned in the region A3. p% is an adjustable deletion ratio, and is smaller than 100%. 100% is excluded from the deletion ratio since it still needs to prevent the equation deleting the placements in the FL region.

It is noted that the light source FL is an exemplary example, and the prevent invention is not limited herein and is applicable to another light source.

By formulating equation (5), count[i] in equation (4) is formed in accordance with the chromatic aberration in one or more gray regions. By the above-described scheme, the other possible chromatic aberration occurred on the-skin color, blue sky, sunset, or the like can be solved.

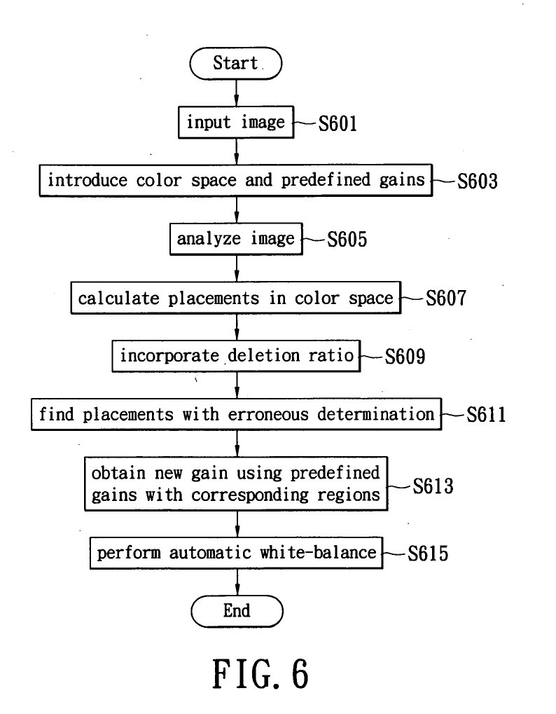

FIG. 6 shows a flow chart of the method of automatic white-balance calibration for solving an erroneous determination of light source by taking the overlapping regions into consideration.

In the beginning, such as the step S601, an image is inputted into the claimed system. Then a predefined gain with corresponding to a gray region of a color space is introduced (step S603). Next, the image is under an analysis that is used to extract the red value, green value and blue value of each pixel therein (step S605). The values are transformed into the positions in the color space by referring to the ratio (such as B/C, R/G) between the placements. After that, the placements positioned in one or more gray regions can be obtained after sketching the positions in the color space (step S607).

The embodiment further takes the placements positioned in the overlapping regions into consideration since these placements may cause the chromatic aberration rather than the preferred effect. Particularly, the aspect of adjustable weighting is incorporated into the gray regions. In step S609, a deletion ratio is introduced and used to delete a portion of the placements positioned in the overlapping regions. By performing the deletion, the chromatic aberration caused by the possible erroneous determination of the light source can be eliminated.

The following step S611 is to determine the placements positioned in the gray regions, and find out the placements with possible erroneous determination. That is to obtain the placements positioned in the overlapping regions. After that, a portion of the placements is the deleted according to the deletion ratio. Next, the number of the placements positioned in each gray region is obtained as summing up the placements at each region. Therefore the new accumulative values with corresponding gray regions are obtained after deleting the possible erroneous placements. The new accumulative values take the place of count[i] in equation (4). Equation (6) is formed as:

Gain_new=(Σcount_new[i]*PreDefGain[i])/(Σcount_new[i]) (6)

wherein count_new[i] represents the new accumulative values after deleting the portion of placements in the overlapping regions.

Next, equation (6) is used to have a new gain as incorporating the placements and the gain in each gray region (step S613). Consequently, the method performs the automatic white-balance process in accordance with the new gain.

In the conventional color space, there generally exists overlapping regions between the gray regions with corresponding different light sources. Since the placements positioned in the overlapping regions may cause the erroneous determination of light source, the present invention incorporates the aspect of adjustable weighting for each region in order to solve the chromatic aberration therefor.

In the preferred embodiment, the invention uses a linear combination of the predefined gains and the placements in each region to obtain a new gain. This new gain can be used to prevent the erroneous determination of the light source. A user may decide his preferred tone by adjusting the predefined gain.

To sum up, the method of automatic white-balance calibration is provided. Firstly a predefined gain is used, and a new gain is then obtained by linearly combining the predefined gains and each region's placements in accordance with a proportional relationship. The weighting value based on the number of placements in each gray region is incorporated to enhancing the white-balance. The erroneous determination of light source due to the chromatic aberration can be prevented.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method of automatic white-balance calibration, comprising:
inputting an image;
introducing a color space and a plurality of predefined gains of gray regions in the color space;
analyzing the image, operatively to extract a red value, a green value, and a blue value of each pixel;
calculating each pixel's placement in the color space, and determining a plurality of placements within each gray region;
accumulating a number of the placements within each gray region;
obtaining a new gain according to the placements within each gray region and the gray region's predefined gain; and
performing an automatic white-balance process according to the new gain.

2. The method of claim 1, wherein the new gain is formulated as:
(Σcount[i]*PreDefGain[i])/(Σcount[i]), wherein i represents the gray region of the color space, count[i] represents an accumulated value, and PreDefGain[i] represents the predefined gain for each gray region.

3. The method of claim 2, wherein the accumulated value is a number of the placements in all gray regions, or the number of the placements within parts of the gray regions with more counts.

4. The method of claim 1, wherein the method further includes a step of determining the placements in an overlapping region between the gray regions when the method is to calculate the pixel's placement in the color space.

5. The method of claim 4, wherein a deletion ratio is introduced to delete a portion of placements positioned in the overlapping regions.

6. The method of claim 5, wherein the new gain is formulated as:
(Σcount new[i]*PreDefGain[i])/(Σcount_new[i]), wherein i represents the gray region of the color space, count_new[i] represents the accumulated value in each gray region based on a new accumulated value by deleting the portion of placements positioned in the overlapping region according to the deletion ratio, and PreDefGain[i] represents the predefined gain for each gray region.

7. The method of claim 1, wherein the color space shows a proportional relationship of the red value, the green value and the blue value in each pixel of the image.

8. The method of claim 1, wherein the plurality of predefined gains of the gray regions are introduced in accordance with all light sources in the color space.

9. A method of automatic white-balance calibration, comprising:
inputting an image;
introducing a color space and a plurality of predefined gains for gray regions in the color space;
analyzing the image operatively to extract a red value, a green value, and a blue value of each pixel of the image;
calculating each pixel's placement in the color space, and determining a plurality of placements in each gray region;
introducing a deletion ratio used to delete a portion of placements in an overlapping region between the gray regions;
obtaining the placements of the pixel in the overlapping region;
deleting the portion of placements in the overlapping region according to the deletion ratio;
accumulating a number of the placements in each gray region after the step of deleting the portion of placements in the overlapping region, and
obtaining a plurality of accumulated values in accordance with the gray regions;
calculating a new gain based on the accumulated values and the predefined gains; and
performing an automatic white-balance process according to the new gain.

10. The method of claim 9, wherein the new gain is formulated as:
(Σcount-new[i]*PreDefGain[i])/(Σcount_new[i]), wherein i represents the gray region of the color space, count_new[i] represents the accumulated value for each gray region after deleting the portion of placements in the overlapping region, and PreDefGain[i] represents the predefined gain for each gray region.

11. The method of claim 9, wherein the color space shows a proportional relationship of the red value, the green value and the blue value in each pixel of the image.

12. The method of claim 9, wherein the deletion ratio is a value smaller than 100%.

13. The method of claim 9, wherein the accumulated value is a number of the placements in all gray regions, or the number of the placements within parts of the gray regions having more counts.
